(19) United States
(12) Patent Application Publication
(10) Pub. No.: US 2013/0159095 A1
(43) Pub. Date: Jun. 20, 2013

(54) Intelligent Automatic Brand Personality Agents In Social Media Services

(71) Applicants: Joakim Formo, Akersberga (SE); Farjola Zaloshnja, Solna (SE); Joakim Sõderberg, Solna (SE); Marcus Gardman, Skarholmen (SE)

(72) Inventors: Joakim Formo, Akersberga (SE); Farjola Zaloshnja, Solna (SE); Joakim Sõderberg, Solna (SE); Marcus Gardman, Skarholmen (SE)

(73) Assignee: Telefonaktiebolaget L M Ericsson (publ.), Stockholm (SE)

(21) Appl. No.: 13/328,980

(22) Filed: Dec. 16, 2011

(51) Int. Cl. G06Q 30/02

(52) U.S. Cl. 705/14.49

(57) ABSTRACT

A server includes a transceiver for connecting the server over a social network to a provider server and to a user device, a memory for storing information received from the provider server and a processor for instructing the transceiver to communicate information to the user device if the user device input to a prompt from a user home device communicating with the user device satisfies at least one condition stored in the memory.

### TECHNICAL FIELD

The invention is related to sensor networks and more particularly to optimizing functionality of these sensors.

### BACKGROUND

The phenomenal success and widespread acceptance and use of social media is well known. Due to the omnipresence of social media, companies are making significant efforts in attempting to establish their presence on social networks on the world wide web. More specifically, companies are focusing on having a presence in search engines and social media sites.

Context-profile aware ads such as Google® AdSense®, for example, display small ads based on a personal profile of the user browsing a web site. The displayed ads can also be based on keywords in the active content the user is interacting with at the moment. On Facebook®, companies can create a “page” that provides the company a presence within the social media service.

Keyword-based ads and social media pages are, however, limited by their relatively passive nature. That is, they are not necessarily the focus of users (or customers). What is desired, therefore, is a method for both the ads and the companies' presence to become the active focused component in interaction with users (or customers) without becoming intrusive or irrelevant.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with an exemplary embodiment, a server is disclosed. The server comprises: a transceiver for connecting the server over a social network to a provider server and to a user device; a memory for storing information received from the provider server; and a processor for instructing the transceiver to communicate information to the user device if the user device input to a prompt from a user home device satisfies at least one condition stored in the memory.

In accordance with another exemplary embodiment, a method of connecting a provider server to a user device within a social network is disclosed. The method comprises the steps of: a user home device recommending a course of action to the user device; evaluating a response of the user device to the recommended course of action; and connecting a provider server to the user device if the response of the user device satisfies a pre-determined condition.

In accordance with a further exemplary embodiment, a method for rewarding a user device in a social network is disclosed. The method comprises the steps of: monitoring by an ad server of a response of the user device; comparing the monitored user device response to a pre-defined criteria; and rewarding the user device based on the monitored user device response satisfying the pre-defined criteria wherein the rewarding includes providing an acknowledgement to the user device.

In accordance with yet another embodiment, a system for connecting entities in social network is disclosed. The system comprises: a user device; a provider server associated with an entity providing a product or a service and for providing information about the entity; and an ad server connected to the user device and to the provider server, the ad server receiving information from the provider server and evaluating a user input to the user device and communicating information to the user device from the provider server if the user input satisfies a pre-determined condition.

### BRIEF DESCRIPTION OF THE DRAWINGS

The objects and advantages of the invention will be understood by reading the following detailed description in conjunction with the drawings in which:

FIG. 1 illustrates a system in accordance with exemplary embodiments;

FIGS. 2 and 3 illustrate methods in accordance with exemplary embodiments;

FIG. 4 illustrates a server in accordance with exemplary embodiments; and

FIG. 5 illustrates an interaction between system entities in a social network in accordance with exemplary embodiments.

### DETAILED DESCRIPTION

The various features of the invention will now be described with reference to the figures, in which like parts are identified with the same reference characters or numerals.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors).

Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

Within the “Social Web of Things” concept, brands and companies may be regarded as system entities. Each of these system entities may be digital representations or “avatars” of things/products and services, companies or brands. System entities may also be treated as “individuals” with unique profiles so the brand or company itself may be viewed as a “person” that can become a “friend” (in social media terms). This means that a service, brand, company or product avatar may become an active party in the interaction directly with the end user/customer, or indirectly with the user by interacting with third parties (e.g. other system entities), which the end user/customer observes. This is in contrast to the afore-mentioned AdSense and the “pages” of companies, which do not actively interact.

In exemplary embodiments, methods, apparatus and systems are disclosed for enabling a system entity within a “Social Web of Things” to monitor interactions between other system entities and trigger an appropriate response or action from the system (or, monitoring) entity. The monitoring entity may deduce or determine a consequence of these interactions and provide an appropriate response to the one or more of the other system entities engaged in the interaction. The appropriate response may be a gesture such as a “thumbs up” icon (or “Like”) in a social networked context for example.

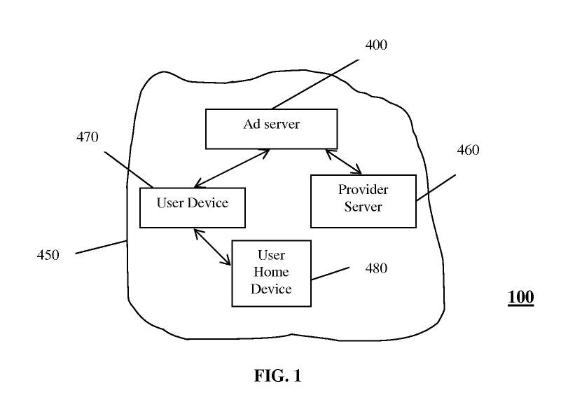

A system in accordance with exemplary embodiments is illustrated in FIG. 1. System 100 may include a server such as ad server 400, a user device 470, a provider server 460 and a user home device 480 within a social network 450. Ad server 400 may also be referred to as an advertisement server.

User device 470 may be a mobile phone, a smartphone, a computer, a computing tablet or a similar device for example. It may also be referred to as a communication device or a network node in the sense that it may be connected to the social network or social web from a network location. User device may include, inter alia, a user interface for displaying information to a user.

Provider server 460 may be associated with a company, an organization or a similar type of entity providing a product, a service or promoting or encouraging a particular type of behavior by users of the user device for example. A company associated with provider server 460 may have a pre-existing relationship with (a user of) the user device.

Ad server 400 and provider server 460 may each be nodes on network 450 and connected to each other. Provider server 460 may provide (the company's) product and/or service profile and corresponding functionality to ad server 400.

User device 470 may also be connected to ad server 400 over network 450. User input to user device 470 may also be available to, or can be monitored by, ad server 400. Provider server 460 may also provide to ad server 400 one or more conditions under which information received by the ad server from provider server 460 may be transmitted to the user device 470. The conditions may include a number of pre-specified (or pre-defined) rules, threshold values, etc. These conditions may also be referred to as pre-defined criteria. The information from provider server 460 (i.e. product/service information and conditions, etc.) may be stored in ad server 400.

Information provided by provider server 460 may also include, but is not limited to, an icon or a profile of the company associated with the provider server. Ad server 400 may also be viewed as being an agent for the company associated with provider server 460. Some of the rules, threshold values and responses can also be generated by ad server 400 based on information provided by the provider server 460. In some embodiments, the conditions, rules and threshold values may also be generated based on past user inputs, etc.

In an exemplary scenario, a dialog (or interaction) may be taking place between a user home device 480 and user device 470. Ad server 400 may monitor this interaction. The user home device 480 may be a home air conditioner communicating with (the owner of the home using) user device 470 over network 450 for example.

The air conditioner (or, user home device 480) may inform the owner/user (of user device 470) that electricity consumption can be reduced by the air conditioner turning itself off whenever the user is not at home. The user home device 480 may ask whether it should turn itself off. This query by the user home device may also be referred to as a prompt. The user may respond affirmatively (via user input to the user device 470).

A company providing the electricity (i.e. corresponding to provider server 460) to the user may have informed the ad server 400 (i.e. a specified condition) that such activity (agreeing to reduce consumption for example) by a user should trigger a communication of company information to the user device. The electricity company (associated with provider server 460) of which the user is an existing customer and “friend” may inform the user of user device 470 via ad server 400 that it “likes” this course of action taken or decision made by a user of user device 470.

An icon such as a thumbs up may be communicated to user device 470 by the ad server 400 as a result of the desirable user course of action. In a social network setting, tokens of appreciation such as “friending” and “like” are desirable. Therefore, users in a social network engage in activities that increases the number of their tokens.

An entity associated with the provider server (such as the electricity company in the example described above) also benefits from such activity as it re-enforces or strengthens its (existing) relationship with the user. A strong brand loyalty and reduction in churn are also achieved. User behavior that benefits the entity's infrastructure or operation can be encouraged.

In the electricity example, users may be convinced to reduce load on the grid during peak hours. Other entities, such as those managing roads for example, may promote reduced road congestion or reduced environmental pollution by recommending car pooling, etc. In the car pooling example, users in a social network can also be recommended as potential car pooling partners.

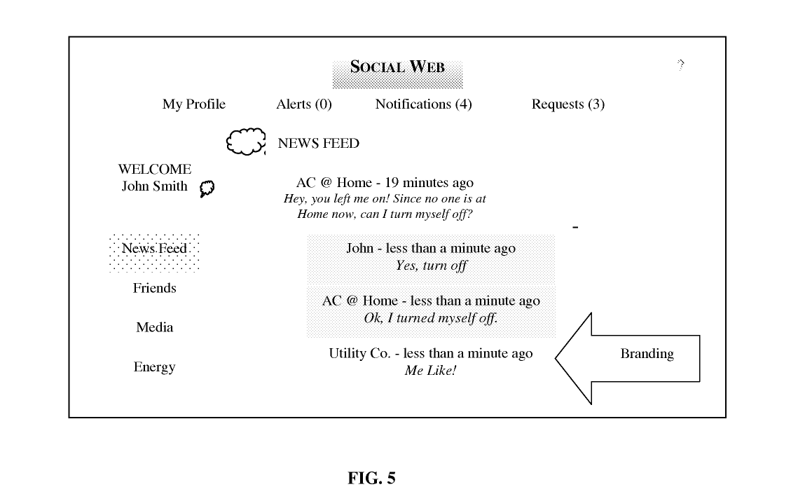

The electricity company may want to promote a particular user behavior and associate itself with such user behavior—in this particular case, the electricity company may want to associate its brand with environmental consciousness and sustainability. The interaction between entities such as user device 470 and user home device 480 over a social network as described above is illustrated in FIG. 5.

A thumbs up icon may be placed within and to the left of “Me Like!” dialog box for example. The interaction rules may be triggered when enabled for certain profiles and certain consequence of actions. Sensors within a room or a home may detect the presence or absence of user(s) for example. These sensors may communicate either directly or via a central home transceiver to the user device.

The terms “ad server” and “advertisement server” are used to distinguish server 400 from other entities such as provider server 460. Server 400, however, is not limited to providing advertisements, etc. Similarly, the term “provider server” is used to distinguish server 460 from server 400.

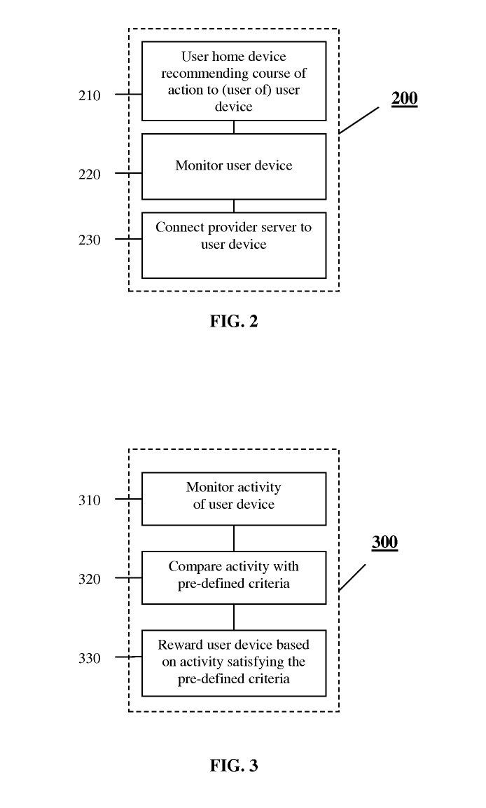

A method in accordance with exemplary embodiments may be described with reference to FIG. 2. In method 200, a user home device (such as the air conditioner in the example described above) may recommend a course of action to a user device at 210. The user device may be monitored at 220 (by ad server 400 of FIG. 1 for example) to determine how a user of the user device responds to the recommended course of action.

If the user responds affirmatively or acts in accordance with the recommendation, a provider server may be connected to the user device. The connection may be in the form of the user device receiving a “thumbs-up” icon or a “like” from the provider server or from an intervening entity (such as ad server 400 for example) that represents the company associated with the provider server.

A method in accordance with exemplary embodiments may also be described with reference to FIG. 3. In method 300, the activity of a system entity (such as the user device in the air conditioner example described above) may be monitored at 310. The monitored activity may be compared to pre-defined criteria at 320. If the monitored activity satisfies a pre-defined criteria, the system entity may be “rewarded” at 330.

The reward may be in the form of the system entity receiving a “thumbs-up” icon or a “like” from an entity representing a company providing products are services for example. The reward may also be in the form of discounts or special offers on products or services from the company. The reward could also be a social network medal or title. The “reward” could also be a punishment such as, for example, a token of dislike, a “thumbs-down”, etc.

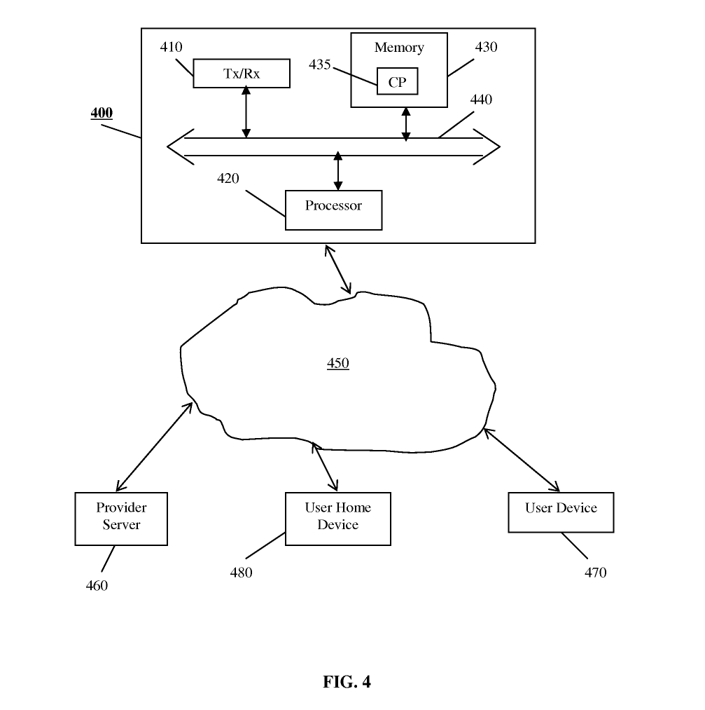

A server 400 according to exemplary embodiments is illustrated in FIG. 4. Server 400 may also be referred to as an ad server. Ad server 400 may include, inter alia, a transceiver 410, a processor 420 and a computer readable medium 430. Transceiver 410, processor 420 and memory 430 may be interconnected via a bus 440.

A provider server 460 may also be connected over a social network 450 to the ad server 400. A user device 470 may also be connected to ad server 400 over social network 450. The transceiver 410 of ad server 400 may receive product or service information from provider server 460. The received information may be stored in memory 430.

Transceiver 410 of ad server 400 may also receive the user input to user device 470. The information representing activity on the user device 470 (such as a user input for example) may be compared with information received (from provider server 460). Based on this comparison, ad server 400 may provide the information received from provider server 460 to a user device as described.

In one embodiment, in order for processor 420 to perform the steps illustrated in FIG. 2, memory 430 may comprise a computer program (CP) 435 with computer program modules which when run by the processor 420 causes the user equipment 400 to perform all or some of the steps illustrated in FIGS. 2 and 3.

In exemplary embodiments as described above, user device input in response to a user home device recommendation has been evaluated (with respect to pre-stored conditions, threshold values, etc.) by the ad server in order to communicate information (product/service information, social network token, etc.) to the user device.

However, in other embodiments, statistical machine learning techniques may be utilized to predict a user behavior based on past user inputs, etc. to form the basis for rewarding the user device with social network tokens. A series of interactions and events between system entities and users may be modeled using statistical machine learning techniques.

The triggering event(s) may be deduced by ad server 400 in one or more of the following (non exhaustive list of) ways:

A specific brand may want to be associated with a consequence of a series of interactions between entities in the social web. For example, with reference to the electricity company scenario described above, the electricity company “likes” an action that is designed to reduce electricity consumption. The consequence in this case may be the reduced electricity consumption.

Certain set values of multiple system entities may be matched. For example, if a user who owns a Sony Ericsson® mobile device adds a new Sony® TV as a friend, the Sony Ericsson mobile phone which is an already existing “friend”, would “like” the fact that a Sony TV was befriended. In this case, the matching value might be that the profiles of the two things were matched by their affiliated brands.

The match between system entities may be linked to interaction or event history. For example, if a user's car states that the user has improved his or her driving technique in a way that reduces wear and tear on the car and fuel consumption compared to before, the car may express appreciation and acknowledge the driver's improved driving technique. In this scenario, the user or driver may receive the afore-mentioned “thumbs-up” logo or a “like” from the car.

There may also be thresholds for the responses which define certain levels of value for a certain user action. The electricity company in the above described example may not necessarily “Like” a user if the user just authorized turning off a lamp while the user is away from a room. The company may “Like” the user if the user sets up a rule that makes all lighting in the home turn off when he or she is not at home.

Several advantages may be realized by exemplary embodiments as described. These include: the expressions of preference from system entities encouraging certain kinds of favorable behavior or action by users while reinforcing the core user interaction paradigm of the Social Web of Things concept. That is, the mental model of a network built of social relations where all system entities are participants.

Companies can obtain a novel channel for communicating their brands. By having their product or service express certain preferences and being associated with certain behavior or action will be a powerful branding at a proximate position to the user/customer without being perceived as being invasive.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. An advertising server (400) comprising:
a transceiver (410) for connecting the advertising server over a social network (450) to a provider server (460) and to a user device (470);
a memory (430) for storing information received from the provider server, the received information including product or service information; and
a processor (420) for instructing the transceiver to communicate information to the user device if a response of the user device to a prompt from a user home device (480) communicating with the user device satisfies at least one condition stored in the memory.

2. The advertising server of claim 1, wherein the transceiver is further for receiving the at least one condition from the provider server.

3. The advertising server of claim 2, wherein the transceiver is for receiving the product or service information from the provider server, said provider server being associated with an entity providing the product or service.

4. The advertising server of claim 1, wherein the transceiver is for receiving the user device response.

5. The advertising server of claim 4, wherein the processor is for comparing the user device response with the at least condition stored in the memory.

6. The advertising server of claim 1, wherein the transceiver for communicating a social network token to the user device.

7. A method (200) of connecting a provider server to a user device within a social network comprising:
a user home device recommending (210) a course of action to the user device;
evaluating (220) a response of the user device to the recommended course of action; and
connecting (230) a provider server to the user device if the response of the user device satisfies a pre-determined condition.

8. The method of claim 7, wherein the connection is a sign of appreciation by an entity associated with the provider server, the entity providing product or service information.

9. The method of claim 7, wherein the connection is a social network token.

10. The method of claim 9, wherein the token is a thumbs up icon.

11. The method of claim 9, wherein the token is a like.

12. A computer program (435) comprising computer readable program modules for rewarding a user device in a social network which when run on a advertising server causes the advertising server terminal to:
monitor (310) user input to the user device;
compare (320) the monitored user input to a pre-defined criteria; and
reward (330) the user device based on the monitored user input satisfying the pre-defined criteria wherein the rewarding includes providing an acknowledgement to the user device.

13. The computer program of claim 12, wherein the acknowledgement is communicating an icon to the user device for display on a user interface of the user device.

14. The computer program of claim 12, wherein the acknowledgement is a friending of the user device by the ad server.

15. A system (100) for connecting entities in a social network (450) comprising:
a user device (470);
a provider server (460) associated with an entity providing a product or a service and for providing information about the entity; and
an ad server (400) connected to the user device and to the provider server, the ad server receiving information from the provider server and evaluating a user input to the user device and communicating information to the user device from the provider server if the user input satisfies a pre-determined condition.

16. The system of claim 15, wherein the provider server is associated with a utility company.

17. The system of claim 16, wherein the user home device is an air conditioner.

18. The system of claim 15, wherein the pre-determined condition is an affirmative response to a recommended course of action from the user home device.

19. The system of claim 18, wherein the recommended course of action a reduction in energy consumption.

20. The system of claim 15, wherein the information communicated to the user device is a social network token.

21. The system of claim 20, wherein the token is a thumbs up icon.

22. The system of claim 20, wherein the token is a like.
